(19) United States
(12) Patent Application Publication
(10) Pub. No.: US 2006/0068253 A1
(43) Pub. Date: Mar. 30, 2006

(54) GAS BARRIER FOR ELECTROCHEMICAL CELLS

(75) Inventors: David E. Henderson, Guilford, CT (US); Everett Anderson, Glastonbury, CT (US); Durwood Beringer, Windsor, CT (US)

Correspondence Address: CANTOR COLBURN, LLP, 55 GRIFFIN ROAD SOUTH, BLOOMFIELD, CT, 06002, US

(73) Assignee: PROTON ENERGY SYSTEMS, INC, Wallingford, CT (US)

(21) Appl. No.: 10/711,658

(22) Filed: Sep. 29, 2004

(51) Int. Cl. H01M 8/10; H01M 2/14

(52) U.S. Cl. 429/30; 429/129

(57) ABSTRACT

A membrane-electrode-assembly (MEA) for an electrochemical cell employing a gas is disclosed. The MEA includes a proton exchange membrane, a first electrode disposed on one side of the membrane, a second electrode disposed on the opposite side of the membrane, and a metallic layer disposed between the membrane and the first electrode, the membrane and the second electrode, or both. The metallic layer has a composition and thickness suitable for reducing the amount of gas crossover at the membrane by equal to or greater than about 20% as compared to the amount of gas crossover at the membrane in the absence of the metallic layer.

### BACKGROUND OF INVENTION

The present disclosure relates generally to electrochemical cells, particularly to electrochemical cells having a gas barrier, more particularly to electrochemical cells having a hydrogen barrier, and even more particularly to electrolysis cells having a hydrogen barrier.

Electrochemical cells are energy conversion devices, usually classified as either electrolysis cells or fuel cells. A proton exchange membrane electrolysis cell can function as a hydrogen generator by electrolytically decomposing water to produce hydrogen and oxygen gas, and can function as a fuel cell by electrochemically reacting hydrogen with oxygen to generate electricity. Referring to FIG. 1, which is a partial section of a typical anode feed electrolysis cell 100, process water 102 is fed into cell 100 on the side of an oxygen electrode (anode) 116 to form oxygen gas 104, electrons, and hydrogen ions (protons) 106. The reaction is facilitated by the positive terminal of a power source 120 electrically connected to anode 116 and the negative terminal of power source 120 connected to a hydrogen electrode (cathode) 114. The oxygen gas 104 and a portion of the process water 108 exits cell 100, while protons 106 and water 110 migrate across a proton exchange membrane 118 to cathode 114 where hydrogen gas 112 is formed.

Another typical water electrolysis cell using the same configuration as is shown in FIG. 1 is a cathode feed cell, wherein process water is fed on the side of the hydrogen electrode. A portion of the water migrates from the cathode across the membrane to the anode where hydrogen ions and oxygen gas are formed due to the reaction facilitated by connection with a power source across the anode and cathode. A portion of the process water exits the cell at the cathode side without passing through the membrane.

A typical fuel cell uses the same general configuration as is shown in FIG. 1. Hydrogen gas is introduced to the hydrogen electrode (the anode in fuel cells), while oxygen, or an oxygen-containing gas such as air, is introduced to the oxygen electrode (the cathode in fuel cells). Water can also be introduced with the feed gas. The hydrogen gas for fuel cell operation can originate from a pure hydrogen source, hydrocarbon, methanol, or any other hydrogen source that supplies hydrogen at a purity suitable for fuel cell operation (i.e., a purity that does not poison the catatlyst or interfere with cell operation). Hydrogen gas electrochemically reacts at the anode to produce protons and electrons, wherein the electrons flow from the anode through an electrically connected external load, and the protons migrate through the membrane to the cathode. At the cathode, the protons and electrons react with oxygen to form water, which additionally includes any feed water that is dragged through the membrane to the cathode. The electrical potential across the anode and the cathode can be exploited to power an external load.

In other embodiments, one or more electrochemical cells may be used within a system to both electrolyze water to produce hydrogen and oxygen, and to produce electricity by converting hydrogen and oxygen back into water as needed. Such systems are commonly referred to as regenerative fuel cell systems.

Electrochemical cell systems typically include a number of individual cells arranged in a stack, with the working fluids directed through the cells via input and output conduits or ports formed within the stack structure. The cells within the stack are sequentially arranged, each including a cathode, a proton exchange membrane, and an anode. The cathode and anode may be separate layers or may be integrally arranged with the membrane. Each cathode/membrane/anode assembly (hereinafter “membrane-electrode-assembly”, or “MEA”) typically has a first flow field in fluid communication with the cathode and a second flow field in fluid communication with the anode. The MEA may furthermore be supported on both sides by screen packs or bipolar plates that are disposed within, or that alternatively define, the flow fields. Screen packs or bipolar plates may facilitate fluid movement to and from the MEA, membrane hydration, and may also provide mechanical support for the MEA. In order to maintain intimate contact between cell components under a variety of operational conditions and over long time periods, uniform compression may be applied to the cell components. Pressure pads or other compression means are often employed to provide even compressive force from within the electrochemical cell.

At operating conditions, molecules of hydrogen gas may migrate, or permeate, from the hydrogen side of the membrane to the oxygen side, where they may react with oxygen to form process water, thereby resulting in a loss of efficiency due to the reverse migration of some hydrogen. In electrochemical cells operating as electrolysis cells, this loss of efficiency may be more pronounced due to the high operating pressures of the electrolysis cell.

While existing electrochemical cells may be suitable for their intended purpose, there still remains a need for improvement, particularly regarding cell efficiency. Accordingly, a need exists for improved internal cell components of an electrochemical cell, and particularly MEAs, that can operate at sustained high pressures, while offering improved efficiency.

### BRIEF DESCRIPTION OF THE INVENTION

Embodiments of the invention include a membrane-electrode-assembly (MEA) for an electrochemical cell employing a gas. The MEA includes a proton exchange membrane, a first electrode disposed on one side of the membrane, a second electrode disposed on the opposite side of the membrane, and a metallic layer disposed between the membrane and the first electrode, the membrane and the second electrode, or both. The metallic layer has a composition and thickness suitable for reducing the amount of gas crossover at the membrane by equal to or greater than about 20% as compared to the amount of gas crossover at the membrane in the absence of the metallic layer.

Other embodiments of the invention include an electrochemical cell having a plurality of membrane-electrode-assemblies (MEAs) alternatively arranged with a plurality of flow field members between a first cell separator plate and a second cell separator plate, wherein at least one MEA is as described above. Here, however, the metallic layer also has a composition and thickness suitable for operating the electrochemical cell at an operating pressure difference across a MEA of equal to or greater than about 50 pounds-per-square-inch (psi).

Further embodiments of the invention include an electrolysis cell having a plurality of membrane-electrode-assemblies (MEAs) alternatively arranged with a plurality of flow field members between a first cell separator plate and a second cell separator plate, wherein at least one MEA is as described above. Here, however, the metallic layer has a composition and thickness suitable for operating the electrochemical cell at an operating pressure difference across a MEA of equal to or greater than about 100 pounds-per-square-inch (psi).

### BRIEF DESCRIPTION OF THE DRAWINGS

Referring to the exemplary drawings wherein like elements are numbered alike in the accompanying Figures:

FIG. 1 depicts a schematic diagram of a partial electrochemical cell showing an electrochemical reaction for use in accordance with embodiments of the invention;

FIG. 2 depicts an exploded assembly isometric view of an exemplary electrochemical cell in accordance with embodiments of the invention;

FIG. 3 depicts an exploded assembly section view similar to the assembly of FIG. 2; and

FIG. 4 depicts an exploded assembly isometric view of a membrane-electrode-assembly in accordance with embodiments of the invention.

### DETAILED DESCRIPTION OF THE INVENTION

Embodiments of the invention provide a membrane-electrode-assembly (MEA) for an electrochemical cell, and particularly for an electrolysis cell, having a thin, semicontinuous or porous, metallic layer disposed between one or both sides of the membrane and the adjacent electrode, so as to reduce the hydrogen crossover at the membrane and increase the overall efficiency of the cell.

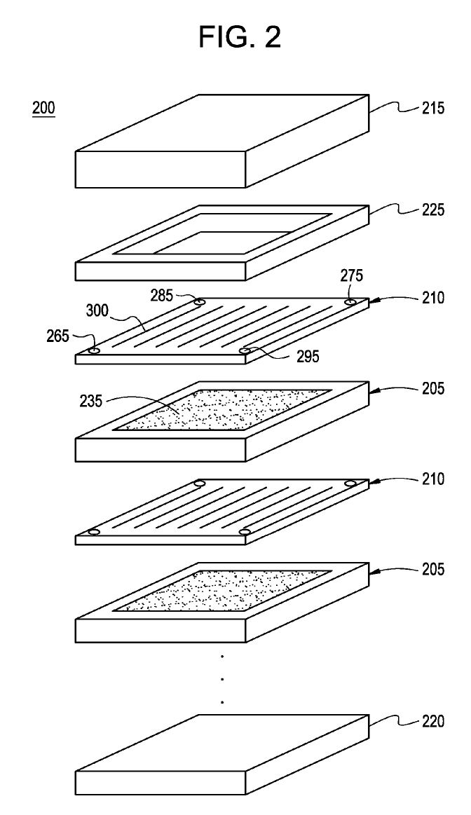

Referring now to FIGS. 2-4, an exemplary electrochemical cell (cell) 200 that may be suitable for operation as an anode feed electrolysis cell, cathode feed electrolysis cell, fuel cell, or regenerative fuel cell is depicted in an exploded assembly isometric view. Thus, while the discussion below may be directed to an anode feed electrolysis cell, cathode feed electrolysis cells, fuel cells, and regenerative fuel cells are also contemplated. Cell 200 is typically one of a plurality of cells employed in a cell stack as part of an electrochemical cell system. When cell 200 is used as an electrolysis cell, power inputs are generally between about 1.48 volts and about 3.0 volts, with current densities between about 50 A/ft² (amperes per square foot) and about 4,000 A/ft². When used as a fuel cells power outputs range between about 0.4 volts and about 1 volt, and between about 0.1 A/ft² and about 10,000 A/ft². The number of cells within the stack, and the dimensions of the individual cells is scalable to the cell power output and/or gas output requirements. Accordingly, application of electrochemical cell 200 may involve a plurality of cells 200 arranged electrically either in series or parallel depending on the application. Cells 200 may be operated at a variety of pressures, such as up to or exceeding 50 psi (pounds-per-square-inch), up to or exceeding about 100 psi, up to or exceeding about 500 psi, up to or exceeding about 2500 psi, or even up to or exceeding about 10,000 psi, for example.

In an embodiment, cell 200 includes a plurality of membrane-electrode-assemblies (MEAs) 205 alternatively arranged with a plurality of flow field members 210 between a first cell separator plate 215 and a second cell separator plate 220. In an embodiment, flow field members 210 are bipolar plates, which are also herein referenced by numeral 210. Gaskets 225 may be employed generally for enhancing the seal between the first and second cell separator plates 215, 220 and the associated bipolar plate 210, and between MEA 205 and an adjacent bipolar plate 210. Bipolar plate 210 may be a unitary plate or a laminated arrangement of layers made of titanium, zirconium, stainless steel, or any other material found to be suitable for the purposes disclosed herein, such as niobium, tantalum, carbon steel, nickel, cobalt, and associated alloys, for example. Flow ports, depicted generally at 265, 275, 285 and 295, permit fluid flow into and out of flow fields, depicted generally at 300, of bipolar plate 210.

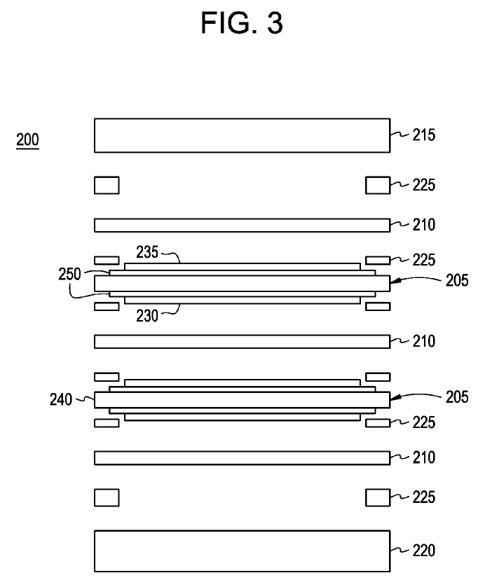

MEA 205 has a first electrode (e.g., anode, or oxygen electrode) 230 and a second electrode (e.g., cathode, or hydrogen electrode) 235 disposed on opposite sides of a proton exchange membrane (membrane) 240, best seen by referring to FIG. 3. Disposed between one or both of the electrodes 230, 235 and the membrane 240 is a thin metallic layer 250, discussed in more detail below. Bipolar plates 210, which are in fluid communication with electrodes 230 and 235 of an adjacent MEA 205, have a structure that define the flow fields 300 adjacent to electrodes 230 and 235. The cell components, particularly cell separator plates (also referred to as manifolds) 215, 220, bipolar plates 210, and gaskets 225, may be formed with suitable manifolds or other conduits for fluid flow.

In an embodiment, membrane 240 comprises electrolytes that are preferably solids or gels under the operating conditions of the electrochemical cell. Useful materials include proton conducting ionomers and ion exchange resins. Useful proton conducting ionomers include complexes comprising an alkali metal salt, alkali earth metal salt, a protonic acid, or a protonic acid salt. Useful complex-forming reagents include alkali metal salts, alkaline metal earth salts, and protonic acids and protonic acid salts. Counter-ions useful in the above salts include halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt is complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins may include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases. One family of fluorocarbon-type resins having sulfonic acid group functionality is NAFION™ resins (commercially available from E. I. du Pont de Nemours and Company, Wilmington, Del.).

Electrodes 230 and 235 may comprise a catalyst suitable for performing the needed electrochemical reaction (i.e., electrolyzing water and producing hydrogen). Suitable catalysts include, but are not limited to, materials comprising platinum, palladium, rhodium, carbon, gold, tantalum, tungsten, ruthenium, iridium, osmium, alloys of at least one of the foregoing catalysts, and the like.

Metallic layer 250 may contain, be made of, resemble, or have the characteristics of a metal, such as platinum (Pt) or gold (Au), for example. Metallic layer 250 may be formed on membrane 240, may be deposited on membrane 240 via plating, chemical reduction, sputtering, or ion beam assisted deposition for example, or may be layered adjacent to, but in contact with, membrane 240. The thickness and continuity of coverage of metallic layer 250 on membrane 240 is such that the metallic layer 250 has low hydrogen permeability as well as good catalytic properties, and effectively reduces the amount of hydrogen crossover at the membrane 240 as compared to a MEA 205 having no metallic layer 250. In an embodiment, metallic layer is thin, being on the order of equal to or greater than about 1 mil (1 mil equals 0.001 inches) and equal to or less than about 10 mils. However, it is contemplated that thinner metallic layers may also be suitable for the purposes herein disclosed, where the thickness is equal to or greater than about 1 micro-inch (1 micro-inch equals 0.000001 inches), or even equal to or greater than about 1 molecule thick.

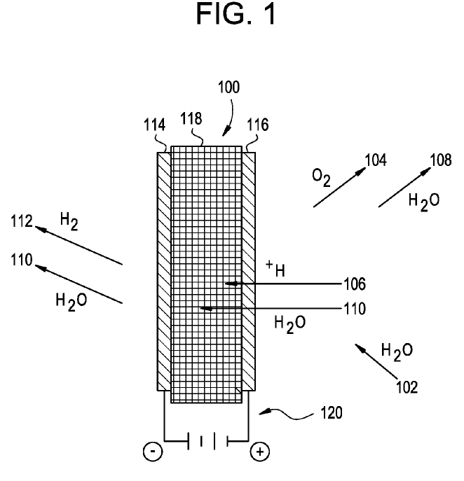

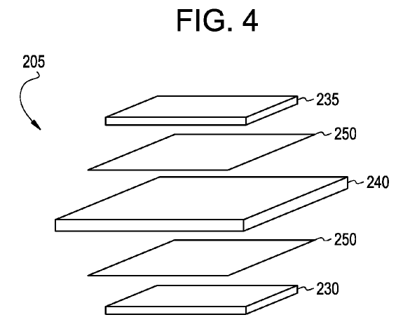

In order for hydrogen ions (protons) 106 to be able to migrate across membrane 118 (FIG. 1) or 240 (FIGS. 3 and 4) (hereinafter referred to as membrane 240), it is important that the metallic layer 250 not be a complete barrier with zero permeability to hydrogen. That is, the membrane 240 is pervious to hydrogen, or hydrogen ions specifically, at operating pressures of equal to or greater than about 50 psi, but only to a defined degree. Here, the degree of hydrogen permeation is defined as a reduction in the amount of permeation at a membrane 240 having a metallic layer 250 as compared to the amount of permeation at a membrane 240 being absent metallic layer 250. For example, and at a defined operating pressure and temperature, if MEA 205 in the absence of metallic layer 250 has a hydrogen permeability normalized to 1.0, then an embodiment of the invention under similar conditions having metallic layer 250, has a hydrogen permeability of equal to or less than about 0.9, an alternative embodiment has a hydrogen permeability of equal to or less than about 0.8, a further alternative embodiment has a hydrogen permeability of equal to or less than about 0.7, and yet a further alternative embodiment has a hydrogen permeability of equal to about 0.6. It is contemplated that embodiments of the invention may also include a membrane-metallic-layer arrangement having a hydrogen permeability of equal to or less than about 0.6, which may be accomplished by increasing the amount of coverage of metallic layer 250 on membrane 240 in the active area of membrane 240, which is defined generally as that area of membrane 240 adjacent flow field 300. As such, the metallic layer 250 may be said to have a composition and thickness suitable for reducing the amount of hydrogen crossover at the membrane 240 by equal to or greater than about 20%, or alternatively equal to or greater than about 30%, as compared to the amount of hydrogen crossover at the membrane 240 in the absence of the metallic layer 250.

Experimental data performed on a membrane 240 with and without a semicontinuous layer of platinum resulted in a change in permeability of nitrogen across membrane 240 from about 2.6 micro-liters-per-second to about 1.6 micro-liters-per-second, which is a reduction in permeability of about 38%. Although the experimental data was generated using nitrogen, it is contemplated that similar results will occur in the presence of hydrogen. As used herein, the term semicontinuous refers to a layer that provides only a partial barrier to hydrogen, and is not intended to imply a lack of continuity of the metallic material from one edge of membrane 240 to another, by any path, whether the path may be straight, circuitous or otherwise. The semicontinuous layer may also be viewed as being a porous layer, or in more general terms, a layer pervious to hydrogen. The noted experiment provided a metallic layer 250 of platinum on membrane 240 by a reduction method that used 200 grams of NaBH₄ in 165 Liters of 0.1 N NaOH at 77 degrees-Fahrenheit with a dwell time of one hour.

Experimental observations suggest that the reduction in permeability is a function of the amount of coverage of metallic layer 250 on membrane 240, with equal to or greater than about 20% coverage resulting in equal to or greater than about 20% reduction in hydrogen permeability. While not being held to any particular scientific principle, it is contemplated that the percent reduction in permeability with respect to the percent coverage of metallic layer 250 approximates a linear function, thereby resulting in equal to or greater than about 30% reduction in hydrogen permeability for equal to or greater than about 30% coverage.

As can be seen, the percent coverage and thickness of metallic layer 250 may vary over a wide range of values, as long as the metallic layer 250 has a composition and thickness suitable for reducing the amount of hydrogen crossover at the membrane 240 as compared to the amount of hydrogen crossover at the membrane 240 in the absence of the metallic layer 250.

Electrodes 230 and 235 may be formed on metallic layer 250, or may be layered adjacent to, but in contact with, metallic layer 250. In an embodiment having only a single metallic layer 250 adjacent to membrane 240 in MEA 205, an electrode 230 or 235 may be formed on membrane 240, or may be layered adjacent to, but in contact with, membrane 240.

While FIGS. 2-4 have been described as providing a MEA 205 with metallic layer 250 suitable for use in an electrochemical cell 200 at an operating pressure difference across the MEA 205 of equal to or greater than about 50 psi, embodiments of the invention may also be suitable for use in a fuel cell at an operating pressure difference across the MEA 205 of less than 50 psi, and in an electrolysis cell (also depicted as and referred to by numeral 200) at an operating pressure difference across the MEA 205 of equal to or greater than about 100 psi.

While embodiments of the invention have described a metallic layer 250 suitable for acting as a hydrogen barrier in an electrochemical cell to reduce the crossover of hydrogen, embodiments of the invention may also be used to reduce the crossover of chemical species other than hydrogen, such as methanol in a DMFC (direct methanol fuel cell), oxygen in an oxygen generator, and chlorine in a chlorine generator, for example. Accordingly, embodiments of the invention are not limited to just the reduction of crossover of hydrogen in a hydrogen generator.

As disclosed, some embodiments of the invention may include some of the following advantages: improved cell efficiency by reducing the amount of hydrogen crossover at the membrane; and, the ability to change the propensity for hydrogen crossover at the membrane by changing the amount of coverage of the metallic layer.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A membrane-electrode-assembly (MEA) for an electrochemical cell employing a gas, the MEA comprising:
a proton exchange membrane;
a first electrode disposed on one side of the membrane;
a second electrode disposed on the opposite side of the membrane; and
a metallic layer disposed between the membrane and the first electrode, the membrane and the second electrode, or both;
wherein the metallic layer has a composition and thickness suitable for reducing the amount of gas crossover at the membrane by equal to or greater than about 20% as compared to the amount of gas crossover at the membrane in the absence of the metallic layer.

2. The MEA of claim 1, wherein the gas comprises hydrogen.

3. The MEA of claim 2, wherein:
the metallic layer has a composition and thickness suitable for reducing the amount of hydrogen crossover at the membrane by equal to or greater than about 30% as compared to the amount of hydrogen crossover at the membrane in the absence of the metallic layer.

4. The MEA of claim 2, wherein:
the metallic layer comprises platinum, gold, or any combination comprising at least one of the foregoing.

5. The MEA of claim 2, wherein:
the metallic layer is semicontinuous.

6. The MEA of claim 2, wherein:
the metallic layer is porous.

7. The MEA of claim 2, wherein:
the metallic layer is pervious to hydrogen ions.

8. The MEA of claim 2, wherein;
the metallic layer covers equal to or greater than about 20% of the active area of the membrane.

9. The MEA of claim 8, wherein:
the metallic layer covers equal to or greater than about 30% of the active area of the membrane.

10. The MEA of claim 2, wherein:
the metallic layer is deposited on a surface of the membrane.

11. The MEA of claim 10, wherein:
the metallic layer is deposited on the surface of the membrane via plating, chemical reduction, or ion beam assisted deposition.

12. The MEA of claim 2, wherein:
the metallic layer has a thickness equal to or greater than about 1 molecule thickness.

13. The MEA of claim 12, wherein:
the metallic layer has a thickness equal to or greater than about 1 micro-inch.

14. The MEA of claim 13, wherein:
the metallic layer has a thickness equal to or greater than about 1 mil.

15. The MEA of claim 2, wherein:
the first electrode is disposed on the oxygen electrode side of the MEA;
the second electrode is disposed on the hydrogen electrode side of the MEA; and
the metallic layer is disposed only between the membrane and the second electrode.

16. An electrochemical cell, comprising:
a plurality of membrane-electrode-assemblies (MEAs) alternatively arranged with a plurality of flow field members between a first cell separator plate and a second cell separator plate;
wherein at least one MEA comprises:
a proton exchange membrane;
a first electrode disposed on one side of the membrane;
a second electrode disposed on the opposite side of the membrane; and
a metallic layer disposed between the membrane and the first electrode, the membrane and the second electrode, or both;
wherein the metallic layer has a composition and thickness suitable for reducing the amount of hydrogen crossover at the membrane by equal to or greater than about 20% as compared to the amount of hydrogen crossover at the membrane in the absence of the metallic layer; and
wherein the metallic layer has a composition and thickness suitable for operating the electrochemical cell at an operating pressure difference across the at least one MEA of equal to or greater than about 50 pounds-per-square-inch (psi).

17. The electrochemical cell of claim 16, wherein:
the metallic layer comprises a semicontinuous or porous layer suitable for reducing the amount of hydrogen crossover at the membrane by equal to or greater than about 30% as compared to the amount of hydrogen crossover at the membrane in the absence of the metallic layer.

18. The electrochemical cell of claim 16, wherein:
the metallic layer comprises a semicontinuous or porous layer of platinum, gold, or any combination comprising at least one of the foregoing.

19. An electrolysis cell, comprising:
a plurality of membrane-electrode-assemblies (MEAs) alternatively arranged with a plurality of flow field members between a first cell separator plate and a second cell separator plate;
wherein at least one MEA comprises:
a proton exchange membrane;
a first electrode disposed on one side of the membrane;
a second electrode disposed on the opposite side of the membrane; and
a metallic layer disposed between the membrane and the first electrode, the membrane and the second electrode, or both;
wherein the metallic layer has a composition and thickness suitable for reducing the amount of hydrogen crossover at the membrane by equal to or greater than about 20% as compared to the amount of hydrogen crossover at the membrane in the absence of the metallic layer; and
wherein the metallic layer has a composition and thickness suitable for operating the electrochemical cell at an operating pressure difference across the at least one MEA of equal to or greater than about 100 pounds-per-square-inch (psi).

20. The electrochemical cell of claim 19, wherein:
the metallic layer comprises a semicontinuous or porous layer suitable for reducing the amount of hydrogen crossover at the membrane by equal to or greater than about 30% as compared to the amount of hydrogen crossover at the membrane in the absence of the metallic layer.

21. The electrolysis cell of claim 19, wherein:
the metallic layer comprises a semicontinuous or porous layer of platinum, gold, or any combination comprising at least one of the foregoing.
